(19) United States
(12) Patent Application Publication
(10) Pub. No.: US 2026/0303945 A1
(43) Pub. Date: Oct. 1, 2026

(54) ELECTRONIC APPARATUS, CONTROL METHOD FOR ELECTRONIC APPARATUS, AND STORAGE MEDIUM

(71) Applicant: CANON KABUSHIKI KAISHA, Tokyo (JP)

(72) Inventor: SHO ICHIKAWA, Kanagawa (JP)

(21) Appl. No.: 19/567,683

(22) Filed: Mar. 16, 2026

(30) Foreign Application Priority Data
Mar. 26, 2025 (JP) 2025-052438

(51) Int. Cl. H04N 23/611; G06V 20/52; G06V 40/20; G06V 40/50; H04N 23/63; H04N 23/67; H04N 23/69

(52) U.S. Cl. CPC H04N 23/611; G06V 20/52; G06V 40/25; G06V 40/50; H04N 23/633; H04N 23/67; H04N 23/69

(57) ABSTRACT

An electronic apparatus comprising: an acquisition unit configured to acquire user information; a recognition unit configured to recognize an image capturing scene based on image information acquired by an image capturing unit; and a control unit configured to apply, to the electronic apparatus, a setting of a control condition of the electronic apparatus corresponding to the user information and the image capturing scene based on the user information and information on the image capturing scene recognized by the recognition unit.

### BACKGROUND

### Field of the Technology

The present disclosure relates to an electronic apparatus, a control method for an electronic apparatus, and a storage medium.

### Description of the Related Art

In recent years, the number of image capturing apparatuses on which a user-specific setting is possible has increased. For example, a setting of a user-specific capturing mode by a custom capturing mode, a setting of a user-specific operation interface by operation button customization, and the like are possible. However, in a case where the number of settings that can be held by the image capturing apparatus is small and image capturing is performed in various scenes or in a case where the image capturing apparatus is used by a plurality of persons, it is necessary to frequently change the setting, and there were cases where image capturing opportunities were missed.

Japanese Patent Laid-Open No. 2006-165987 discloses reading a control condition associated with information on a fingerprint owner and controlling the operation of a camera based on the control condition.

However, in the technique described in Japanese Patent Laid-Open No. 2006-165987, it is possible to register a plurality of control settings in accordance with an image capturing scene by using a plurality of fingers, but in order to apply a desired setting, it is necessary for the user to perform an operation of reading the fingerprint by using a desired finger. Furthermore, the user needs to recognize the image capturing scene by himself/herself, and also needs to remember which finger corresponds to which control setting. Therefore, the technique described in Japanese Patent Laid-Open No. 2006-165987 has a problem that it is difficult to automatically perform a setting suitable for an image capturing scene for each individual.

### SUMMARY

The present disclosure has been made in view of the above problems, and provides a technique for automatically performing a setting suitable for an image capturing scene for each individual.

According to one aspect of the present disclosure, there is provided an electronic apparatus comprising: an acquisition unit configured to acquire user information; a recognition unit configured to recognize an image capturing scene based on image information acquired by an image capturing unit; and a control unit configured to apply, to the electronic apparatus, a setting of a control condition of the electronic apparatus corresponding to the user information and the image capturing scene based on the user information and information on the image capturing scene recognized by the recognition unit.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are external views of a digital camera according to one embodiment.

FIG. 2 is a block diagram illustrating a configuration example of the digital camera according to one embodiment.

FIG. 3 is a flowchart showing a procedure of processing of determining a control condition based on photographer information and a scene recognition result according to a first embodiment and controlling an operation of the digital camera.

FIG. 4 is an explanatory view illustrating an example of a basic image capturing setting table for registrant according to one embodiment.

FIG. 5 is an explanatory view illustrating an example of a specific scene image capturing setting table for registrant according to one embodiment.

FIGS. 6A to 6D are explanatory views illustrating application notification examples of image capturing settings according to one embodiment.

FIG. 7 is a flowchart showing a procedure of processing of determining a control condition based on photographer information and a scene recognition result according to a second embodiment and controlling an operation of the digital camera.

FIG. 8 is a flowchart showing a procedure of processing of determining a control condition based on photographer information and a scene recognition result according to a third embodiment and controlling an operation of the digital camera.

FIGS. 9A to 9C are explanatory views illustrating MENU setting examples according to the third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

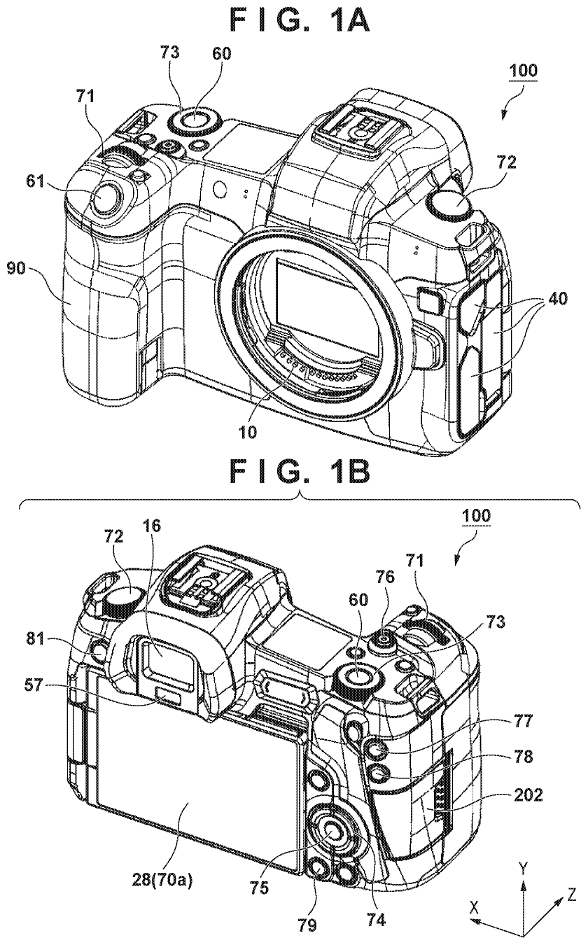

FIGS. 1A and 1B are external views of a digital camera 100 as an example of an apparatus to which the present embodiment can be applied. FIG. 1A is a front perspective view of the digital camera 100, and FIG. 1B is a rear perspective view of the digital camera 100. In FIGS. 1A and 1B, a display unit 28 is a display (e.g., a liquid crystal display) provided on the camera rear surface that displays an image and various types of information. A touch panel 70a can detect a touch operation on a display surface (operation surface) of the display unit 28. A shutter button 61 is an operation unit for giving an image capturing instruction.

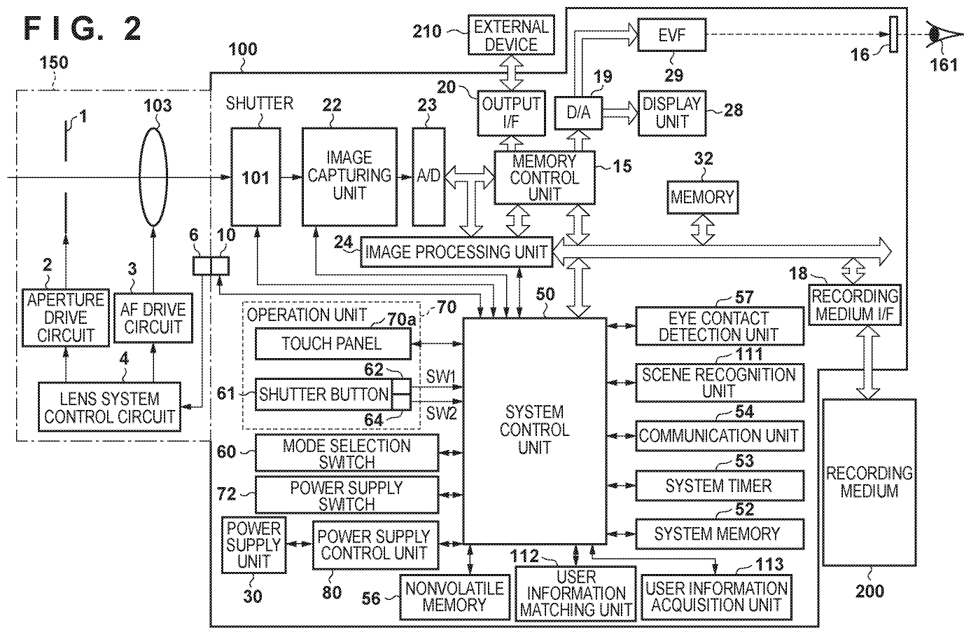

A mode selection switch 60 is an operation unit for switching various modes. A terminal cover 40 is a cover that protects a connector (not illustrated) that connects a connection cable with an external device and the digital camera 100. The connector includes a connection terminal (not illustrated) of a USB cable and an output I/F 20 (described later with reference to FIG. 2), which is an HDMI (registered trademark) output terminal.

A main electronic dial 71 is a rotational operation member included in an operation unit 70 (described later with reference to FIG. 2), and can change setting values such as a shutter speed and an aperture and the like by turning the main electronic dial 71. A power supply switch 72 is an operation member that switches on and off the power supply of the digital camera 100.

A sub-electronic dial 73 is a rotational operation member included in the operation unit 70, and can perform movement of a selection frame, image feed, and the like by turning this sub-electronic dial 73. A cross key 74 is a cross key (four-way key), which is included in the operation unit 70 and can be pressed at up, down, left, and right parts. An operation corresponding to the pressed part of the cross key 74 is possible. A SET button 75 is included in the operation unit 70, is a push button, and is mainly used for deciding a selection item.

A moving image button 76 is used for instruction of start and stop of video capturing (recording). An auto exposure (AE) lock button 77 is included in the operation unit 70, and when it is pressed in an image capturing standby state, an exposure state can be fixed.

An enlargement button 78 is included in the operation unit 70, and is an operation button for turning on and off an enlargement mode during a live view display of the capturing mode. By turning on the enlargement mode and then operating the main electronic dial 71, it is possible to enlarge or reduce a live view image. In a reproduction mode, it functions as an enlargement button for enlarging a reproduced image and increasing an enlargement ratio.

A reproduction button 79 is included in the operation unit 70 and is an operation button for switching between the capturing mode and the reproduction mode. When the reproduction button 79 is pressed during the capturing mode, the mode shifts to the reproduction mode. In the reproduction mode, it is possible to cause the latest image among the images recorded on a recording medium 200 to be displayed on the display unit 28, an electronic view finder (EVF) 29, or an external device 210 (described later with reference to FIG. 2).

A menu button 81 is included in the operation unit 70, and when it is pressed, various settable menu screens are displayed on the display unit 28, the EVF 29, or the external device 210. The user can intuitively perform various settings using a menu screen displayed on the display unit 28, the EVF 29, or the external device 210, and the cross key 74 or the SET button 75.

A communication terminal 10 is a communication terminal for the digital camera 100 to communicate with a lens unit 150 (detachable) described later. An eyepiece unit 16 is an eyepiece unit of an eyepiece unit finder (look-though type finder), and the user can visually recognize a video displayed on the EVF 29 inside through the eyepiece unit 16. An eye contact detection unit 57 is an eye contact detection sensor that detects whether or not the photographer is looking through the eyepiece unit 16. A lid 202 is a lid of a slot that stores the recording medium 200.

A grip portion 90 is a holding portion having a shape that is easily gripped by the right hand when the user holds the digital camera 100. The shutter button 61 and the main electronic dial 71 are arranged at positions that can be operated with the index finger of the right hand in a state of holding the digital camera by gripping the grip portion 90 with the little finger, the ring finger, and the middle finger of the right hand. The sub-electronic dial 73 is arranged at a position that can be operated with the thumb of the right hand in the same state.

### Apparatus Configuration

Next, FIG. 2 is a block diagram illustrating a configuration example of the digital camera 100 according to the present embodiment. In FIG. 2, the lens unit 150 is a lens unit equipped with an interchangeable image capturing lens. A lens 103 usually is constituted by a plurality of lenses, but here, only one lens is illustrated for simplicity. A communication terminal 6 is a communication terminal for the lens unit 150 to communicate with the digital camera 100. The lens unit 150 communicates with a system control unit 50 via this communication terminal 6 and the communication terminal 10 described above. The lens unit 150 controls an aperture 1 via an aperture drive circuit 2 by an internal lens system control circuit 4, and performs focusing by displacing the lens 103 via an AF drive circuit 3.

A shutter 101 is a focal plane shutter that can freely control the exposure time of an image capturing unit 22 under the control of the system control unit 50. The image capturing unit 22 is an image capturing element constituted by a charge coupled device (CCD), a complementary metal-oxide-semiconductor (CMOS) element, or the like that converts an optical image into an electrical signal. An A/D converter 23 is used to convert an analog signal output from the image capturing unit 22 into a digital signal.

An image processing unit 24 performs resizing processing such as predetermined pixel interpolation and reduction and color conversion processing on the data from the A/D converter 23 or the data from a memory control unit 15 described later. The image processing unit 24 performs predetermined calculation processing using the captured image data. The system control unit 50 performs exposure control and distance measurement control based on the calculation result obtained by the image processing unit 24. Accordingly, through-the-lens (TTL) autofocus (AF) processing and automatic exposure (AE) processing, and electronic flash (EF) (flash preliminary light emission) processing are performed. The image processing unit 24 further performs predetermined calculation processing using the captured image data, and performs TTL automatic white balance (AWB) processing based on the obtained calculation result.

The memory control unit 15 controls data transmission and reception among the A/D converter 23, the image processing unit 24, and a memory 32. Output data from the A/D converter 23 is directly written into the memory 32 via the image processing unit 24 and the memory control unit 15 or via the memory control unit 15. The memory 32 stores image data obtained by the image capturing unit 22 and converted into digital data by the A/D converter 23, and image data to be displayed on the display unit 28, the EVF 29, or the external device 210. The memory 32 has sufficient storage capacity for storing a predetermined number of still images, a moving image and sound of a predetermined duration.

The memory 32 also serves as a memory for image display (video memory). A D/A converter 19 converts data for image display stored in the memory 32 into an analog signal to supply it to the display unit 28 and/or the EVF 29. In this manner, the image data for display written in the memory 32 is displayed by the display unit 28 and/or the EVF 29 via the D/A converter 19. The display unit 28 and the EVF 29 perform a display in accordance with the analog signal from the D/A converter 19 on a display such as a liquid crystal display (LCD) or an organic electro-luminescence (EL).

The output I/F 20 supplies the data for image display stored in the memory 32 to the external device 210 as a digital signal. In this manner, the image data for display written in the memory 32 is displayed on the external device 210. The data subjected to A/D conversion by the A/D converter 23 and accumulated in the memory 32 is sequentially transferred to and displayed on the display unit 28, the EVF 29, or the external device 210, whereby live view display (LV display) can be performed. Hereinafter, the image displayed in live view is also referred to as a live view image (LV image).

A nonvolatile memory 56 is an electrically erasable and recordable memory, and for example, a flash-read only memory (ROM) or the like is used. The nonvolatile memory 56 stores constants, programs, and the like, for operating the system control unit 50. The programs mentioned here refer to programs for executing various flowcharts described below in the present embodiment.

The system control unit 50 is a control unit including at least one processor or circuit, and controls the overall operation of the digital camera 100. By reading and executing a program recorded in the nonvolatile memory 56, each processing operation of the embodiment described later is implemented. For example, a random access memory (RAM) is used as the system memory 52, and constants and variables for the operation of the system control unit 50, a program read from the nonvolatile memory 56, and the like are deployed. The system control unit 50 also performs display control by controlling the memory 32, the display unit 28, the EVF 29, and the like.

A system timer 53 is a clocking unit that measures the time used for various controls and the time of a built-in clock. The mode selection switch 60, a first shutter switch 62, a second shutter switch 64, and the operation unit 70 input various operation instructions to the system control unit 50 based on a user operation. The mode selection switch 60 switches the operation mode of the system control unit 50 to any of a still image capturing mode, a video capturing mode, and the like.

The modes included in the still image capturing mode include an automatic capturing mode, an automatic scene determination mode, a manual mode, an aperture priority mode (Av mode), a shutter speed priority mode (Tv mode), and a program AE mode (P mode). There are various scene modes, custom modes, and the like, which are image capturing settings for each image capturing scene. The mode selection switch 60 allows the user to directly switch to any of the aforementioned modes. Alternatively, after temporarily switching to a list screen of the capturing modes by the mode selection switch 60, any of the plurality of displayed modes may be selected and switched using another operation member. Similarly, the video capturing mode may also include a plurality of modes.

The first shutter switch 62 is turned on in the middle of the operation on the shutter button 61 provided in the digital camera 100, that is, what is called half-press (image capturing preparation instruction), and generates a first shutter switch signal SW1. By the first shutter switch signal SW1, image capturing preparation operations such as autofocus (AF) processing, automatic exposure (AE) processing, automatic white balance (AWB) processing, and flash preliminary light emission (EF) processing are started.

The second shutter switch 64 is turned on upon completion of the operation on the shutter button 61, that is, what is called full-press (image capturing instruction), and generates a second shutter switch signal SW2. By the second shutter switch signal SW2, the system control unit 50 starts a series of image capturing processing operations from reading the signal from the image capturing unit 22 to writing, into the recording medium 200, the captured image as an image file.

The operation unit 70 is various operation members as an input unit that accepts the operation from the user. The operation unit 70 includes the shutter button 61, a touch panel 70a, the main electronic dial 71, the power supply switch 72, and the sub-electronic dial 73. Furthermore, the operation unit 70 includes the cross key 74, the SET button 75, the moving image button 76, the AE lock button 77, the enlargement button 78, the reproduction button 79, and the menu button 81.

A power supply control unit 80 includes a battery detection circuit, a DC-DC converter, and, a switch circuit configured to switch a block to be energized, and detects whether a battery is mounted, the type of the battery, and a remaining battery level. In addition, the power supply control unit 80 controls the DC-DC converter based on the detection result and an instruction from the system control unit 50, and supplies a required voltage to each unit including the recording medium 200 for a required period. A power supply unit 30 can include a primary battery such as an alkaline battery and a lithium battery, a secondary battery such as an NiCd battery, an NiMH battery, and a Li battery, and an AC adapter.

A recording medium I/F 18 is an interface with the recording medium 200 such as a memory card or a hard disk. The recording medium 200 is a recording medium such as a memory card for recording a captured image, and is constituted by a semiconductor memory, a magnetic disk, or the like.

A communication unit 54 is connected to an external device wirelessly or by a wired cable, and transmits and receives a video signal and a sound signal. The communication unit 54 can also be connected to a wireless local area network (LAN) or the Internet. The communication unit 54 can also communicate with an external device by Bluetooth (registered trademark) or Bluetooth Low Energy. The communication unit 54 can transmit an image (including an LV image) captured by the image capturing unit 22 and an image recorded on the recording medium 200, and can receive an image and other various types of information from an external device.

The eye contact detection unit 57 is an eye contact detection sensor that detects (approach detection) approach (eye contact) and removal (withdrawal of eye) of an eyeball (eye) 161 with respect to the eyepiece unit 16. The system control unit 50 switches between display (display state) and non-display (non-display state) of the display unit 28 and the EVF 29 in accordance with the state detected by the eye contact detection unit 57.

For example, an infrared proximity sensor can be used as the eye contact detection unit 57, and it is possible to detect approach of some object to the eyepiece unit 16 of the finder incorporating the EVF 29. In a case where an object approaches, infrared rays projected from a light projecting unit (not illustrated) of the eye contact detection unit 57 are reflected and received by a light receiving unit (not illustrated) of the infrared proximity sensor. The distance (eye contact distance) to which the object is approaching from the eyepiece unit 16 can also be determined by the amount of the received infrared light. In this manner, the eye contact detection unit 57 can detect the proximity distance of an object to the eyepiece unit 16. Note that the infrared proximity sensor is an example, and another sensor may be adopted as the eye contact detection unit 57 as long as it can detect approach of an eye or an object that can be regarded as eye contact.

The touch panel 70a and the display unit 28 can be integrally configured. For example, the touch panel 70a is configured so that the light transmittance does not disturb the display of the display unit 28, and is attached to an upper layer of the display surface of the display unit 28. Then, input coordinates on the touch panel 70a are associated with display coordinates on the display screen of the display unit 28. Accordingly, it is possible to provide a graphical user interface (GUI) that gives the user the impression of directly operating the screen displayed on the display unit 28. The touch panel 70a may be any type of touch panel among various types of touch panels such as a resistive film type, a capacitance type, a surface acoustic wave type, an infrared type, an electromagnetic induction type, an image recognition type, and an optical sensor type.

Using captured image data in an operation mode in which an image capturing scene can be determined such as an automatic scene determination mode, a scene recognition unit 111 determines what kind of image capturing scene it is. For example, it is possible to recognize an image capturing scene in which a background and a subject are combined, such as person image capturing under front light, scenery image capturing under backlight, and macro image capturing under blue sky front light. The memory 32 can store an image capturing setting for each image capturing scene.

By operating the digital camera 100, the user of the digital camera 100 registers, in an authorized user database, own user information such as a fingerprint, a face, an iris, and a PIN in advance in association with the user ID or the user name. Then, before the user performs image capturing with the digital camera 100, a user information acquisition unit 113 acquires user information (including at least one of the fingerprint, the face, the iris, and a passkey, for example). The fingerprint information can be acquired by a user's touch via the touch panel 70a, for example. The face information can be acquired from an image capturing the user, for example. The iris information can be acquired from a detection result of an iris sensor (not illustrated) provided in the eyepiece unit 16. As the PIN information, information input by operating the operation unit 70 of the digital camera 100 can be acquired.

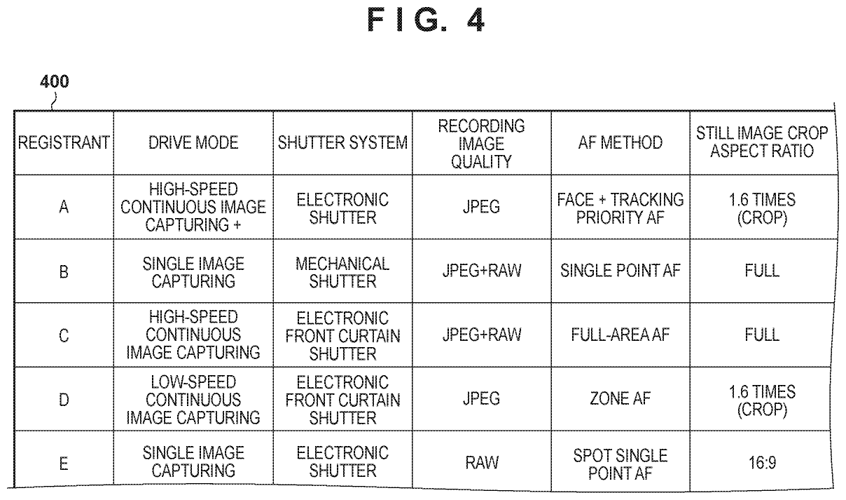

The user information matching unit 112 executes matching processing of the user information. Here, the matching processing refers to processing of confirming whether or not the user information acquired by the user information acquisition unit 113 matches the user information in the authorized user database stored in advance in the memory 32. As a result of matching, in a case where there is an item matching the user information in the authorized user database, the system control unit 50 performs processing of setting, as matched user information on the digital camera 100, the user ID or the user name registered in association with the matched user information. The system control unit 50 can register, in the memory 32, the matched user information set here and the image capturing setting in association with each other. Furthermore, the system control unit 50 can register, in the memory 32, the matched user information, the image capturing scene, and the image capturing setting in association with one another. Details will be described later with reference to FIGS. 4 and 5.

The matched user information is imparted to subsequent image capturing data as photographer information. For example, a photographer tag in Exif is used as a recording location of the photographer information. By imparting the matched user information to the image capturing data as the photographer information in this manner, it is possible to confirm afterwards whether or not the image capturing data is data captured by the authorized user.

Furthermore, the user of the digital camera 100 can perform user registration of a management server system so that an image file can be registered to a management server that is the recording medium 200 using the blockchain technique in order to guarantee the authenticity of the image capturing data. This is a technique of guaranteeing the authenticity of the image by generating a hash value of an image file at a timing when image capturing is performed by the digital camera 100, and registering, in a blockchain, information related to the image file and the hash value as information on the image file.

Only in a case where the photographer information that is the matched user information coincides with the registered user information on the management server, it is possible to more firmly avoid impersonation by a third party by permitting registration of the image file to the management server, and therefore it is possible to increase the reliability of the image file.

The matched user information set once by the user is initialized at the timing when the camera is brought into a capturing end state. Therefore, after the camera is restarted, it is necessary to perform matching of the user information again. Note that in the present embodiment, the matching processing will be described as processing to be performed by the user information matching unit 112, but it is not necessarily performed by the user information matching unit 112, and the matching processing may be performed using a processing unit different from the user information matching unit 112 such as the system control unit 50.

### Processing

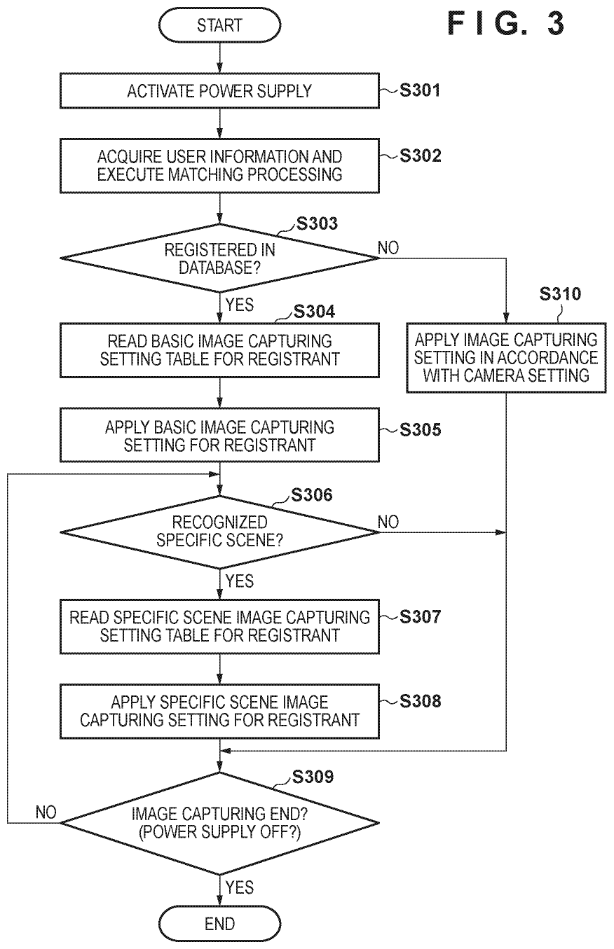

Hereinafter, an example of determining a control condition based on photographer information and a scene recognition result and controlling the operation of the digital camera 100 according to the first embodiment will be described with reference to FIGS. 3, 4, 5, and 6A to 6D.

FIG. 3 is a flowchart showing the procedure of the processing of determining the control condition based on the photographer information and the scene recognition result and controlling the operation of the digital camera 100 according to the first embodiment. Each processing operation in the flowchart of FIG. 3 is implemented by the system control unit 50 deploying, into the system memory 52, a program stored in the nonvolatile memory 56 and executing the program, and controlling each functional block. The flowchart of FIG. 3 is started from a state in which the digital camera 100 is turned off.

In step S301, the digital camera 100 activates the power supply in response to a user operation. In step S302, the user information acquisition unit 113 acquires user information. Here, the user information can include at least one of the fingerprint, the face, the iris, and the passkey. The user information matching unit 112 matches the user information acquired by the user information acquisition unit 113 with the user information present in the authorized user database registered in advance and stored in the memory 32.

In step S303, the user information matching unit 112 determines whether or not the acquired user information matches the user information present in the authorized user database, thereby determining whether or not the user is registered in the authorized user database. In a case where it is registered, the process proceeds to step S304. On the other hand, in a case where it is not registered, the process proceeds to step S310.

In step S304, the system control unit 50 reads the basic image capturing setting table for registrant. For example, in a case where the user is a registrant A, the basic image capturing setting table for the registrant A is read. The basic image capturing setting table for registrant will be described later with reference to FIG. 4. In step S305, the system control unit 50 applies, to the digital camera 100, the basic image capturing setting for registrant read in step S304.

In step S306, the scene recognition unit 111 determines whether or not a specific image capturing scene is recognized based on image information such as a captured video of the digital camera 100 or the like. In a case where the specific image capturing scene is recognized, the process proceeds to step S307. On the other hand, in a case where the specific image capturing scene is not recognized, the process proceeds to step S309.

In step S307, the system control unit 50 reads the specific scene image capturing setting table for registrant. For example, in a case where the user is a registrant B, the specific scene image capturing setting table for the registrant B and for the recognized image capturing scene is read. The specific scene image capturing setting table for registrant will be described later with reference to FIG. 5.

In step S308, the system control unit 50 applies, to the digital camera 100, the specific scene image capturing setting for registrant. In this manner, in a case where the image capturing scene is recognized, the system control unit 50 performs control of applying, to the digital camera 100, the setting of the control condition of the digital camera 100 corresponding to the acquired user information (photographer information) and the recognized image capturing scene (scene recognition result).

In step S309, the digital camera 100 determines whether or not the power supply is turned off by a user operation. In a case where the power supply is turned off, the process is terminated. On the other hand, in a case where the power supply is not turned off, the process returns to step S306 and is repeated. In step S310, the system control unit 50 applies a predetermined image capturing setting in accordance with the camera setting, and the process proceeds to step S309.

As described above, in a case where the image capturing scene is recognized, the system control unit 50 applies the specific scene image capturing setting that is the control condition of the digital camera 100 corresponding to the acquired user information (photographer information) and the recognized image capturing scene (scene recognition result).

On the other hand, in a case where the image capturing scene is not recognized, the basic image capturing setting for registrant set in S305 is applied. In other words, in a case where the image capturing scene is not recognized, the setting that is the control condition of the digital camera 100 corresponding to the acquired user information is applied to the digital camera 100. Furthermore, as a result of matching of the user information, in a case where the user is not registered in the authorized user database, a predetermined image capturing setting is applied.

### Basic Image Capturing Setting Table for Registrant

FIG. 4 is an explanatory view illustrating an example of a basic image capturing setting table for registrant according to the present embodiment. A table 400 is a basic image capturing setting table for each registrant. For example, at least one of the drive mode, the shutter system, the recording image quality, the AF method, and the still image crop aspect ratio can be stored as an image capturing setting changeable for each registrant.

The drive mode can be selected from single image capturing, low-speed continuous image capturing, high-speed continuous image capturing, high-speed continuous image capturing +, and the like. Here, “high-speed continuous image capturing +” indicates an image capturing setting with an image capturing speed higher than that of “high-speed continuous image capturing”. The shutter system can be selected from three types of electronic shutters of an electronic front curtain shutter in which only the front curtain is electronically controlled by the image capturing unit 22, and an electronic shutter in which both the front curtain and a rear curtain are electronically controlled by the image capturing unit 22, in addition to a mechanical shutter by the focal plane method.

One or both of recording image qualities can be selected from different recording image quality of Joint Photographic Experts Group (JPEG) and RAW. The AF method can be selected from various methods such as spot single point AF, single point AF, zone AF, face priority AF, tracking priority AF, and full-area AF. The spot one-point AF is a method for performing focusing in a narrower range than the one-point AF. The one-point AF is a method for focusing on a specific one point, and is a method for performing focusing in a wider range than the spot one-point AF. The zone AF is a method for focusing on a subject in a designated zone. The face priority AF is a method for preferentially focusing on a detected face of a person. The tracking priority AF is a method for performing focusing while tracking a moving subject. The still image crop aspect ratio can be selected from 1.6 times (crop), 16:9, full, and the like.

In the illustrated example, the following basic image capturing settings are stored for the registrants A to E.
Registrant A: high-speed continuous image capturing +, electronic shutter, JPEG, face+tracking priority AF, 1.6 times (crop)
Registrant B: single image capturing, mechanical shutter, JPEG+RAW, single point AF, full
Registrant C: high-speed continuous image capturing, electronic front curtain shutter, JPEG+RAW, full-area AF,
Registrant D: low-speed continuous image capturing, electronic front curtain shutter, JPEG, zone AF, 1.6 times (crop)
Registrant E: single image capturing, electronic shutter, RAW, spot single point AF, 16:9

These settings may be configured to be editable by each user in MENU settings or the like with respect to the initial settings. Here, the user authenticated as a result of matching of the user information may be able to edit own basic image capturing setting. A setting with high use frequency may be applied based on past image capturing data.

### Specific Scene Image Capturing Setting Table for Registrant

FIG. 5 is an explanatory view illustrating an example of a specific scene image capturing setting table for registrant according to the present embodiment. A table 500 is an image capturing setting table for each specific scene for a specific registrant (e.g., the registrant A). For example, at least one of the drive mode, the shutter system, the recording image quality, the AF method, and the still image crop aspect ratio can be stored as an image capturing setting changeable for each image capturing scene. In the illustrated example, the following specific scene image capturing settings are stored for each specific scene.
Bright & person scene: single image capturing, electronic front curtain shutter, JPEG+RAW, single point AF, full
Bright & person (moving object) scene: high-speed continuous image capturing +, electronic shutter, JPEG, face+tracking priority AF, 1.6 times (crop)
Bright & non-person (nature or outdoor) scene: low-speed continuous image capturing, electronic front curtain shutter, RAW, full-area AF, 1.6 times (crop)
Bright & non-person (moving object) scene: high-speed continuous image capturing, mechanical shutter, JPEG, zone AF, full
Bright & non-person (macro) scene: single image capturing, electronic shutter, JPEG+RAW, spot single point AF, 1.6 times (crop)

These settings may be configured to be editable by each user in MENU settings or the like with respect to the initial settings. Here, the user authenticated as a result of matching of the user information may be able to edit own specific scene image capturing setting. A setting with high use frequency may be applied based on past image capturing data. That is, the setting content of the control condition may be a setting in accordance with a past use frequency by the user corresponding to the user information. Furthermore, the setting immediately before the image capturing scene is switched may be stored.

### Notification Examples

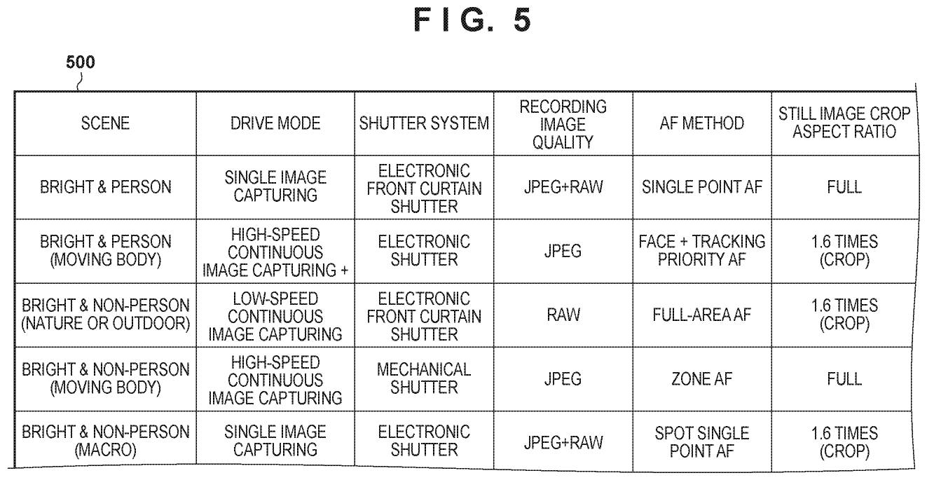

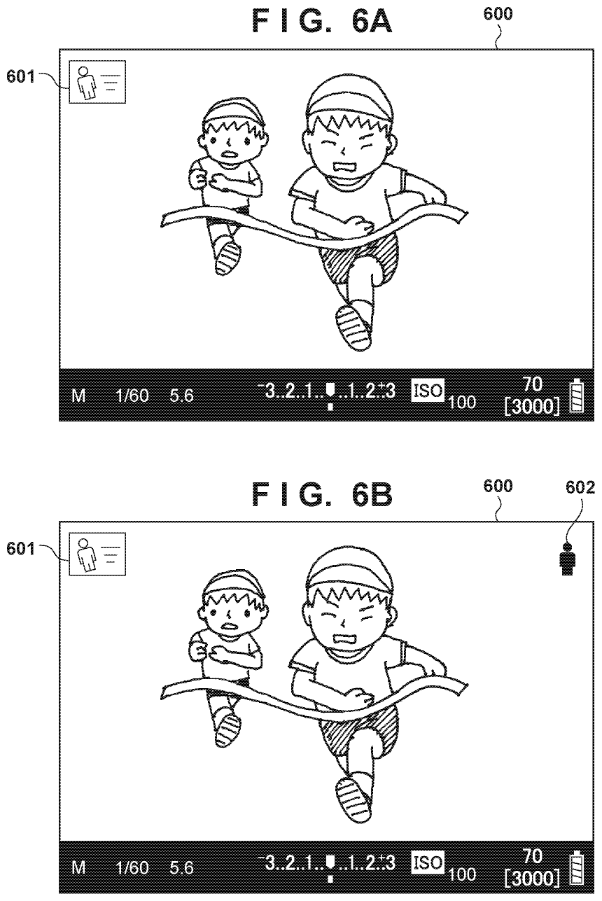

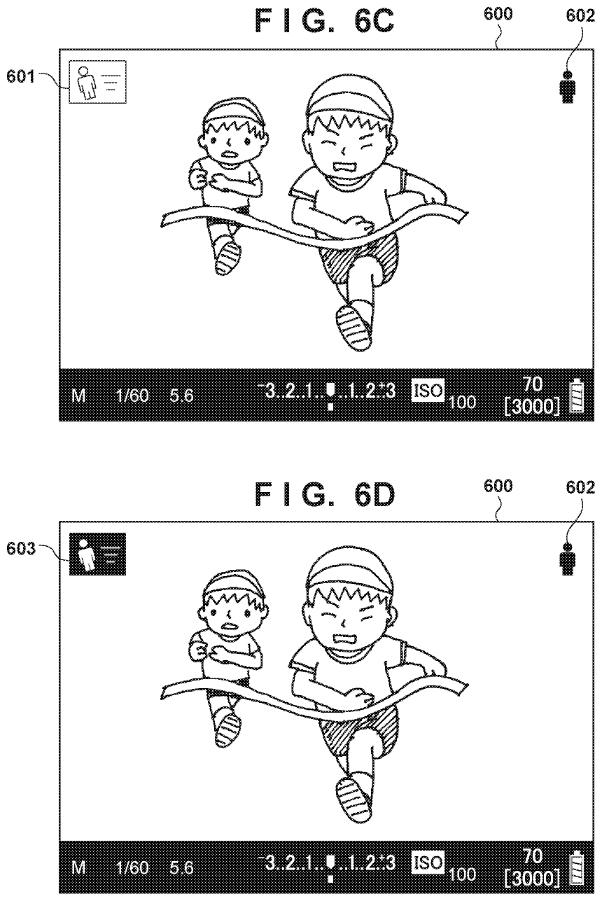

FIGS. 6A to 6D are explanatory views illustrating application notification examples of image capturing settings according to the present embodiment. FIG. 6A is a display example of the EVF 29 before the basic image capturing setting for registrant is applied. FIG. 6B is a display example of the EVF 29 after the basic image capturing setting for registrant is applied. FIG. 6C is a display example of the EVF 29 before the specific scene image capturing setting for registrant is applied. FIG. 6D is a display example of the EVF 29 after the specific scene image capturing setting for registrant is applied.

A display screen 600 illustrates an example of LV display. An icon 601 is an icon indicating the image capturing scene determined by the scene recognition unit 111 regarding the display screen 600. In this manner, display control of causing the display unit 28 of the digital camera 100 to display the icon 601 indicating the recognized image capturing scene may be performed. The icon 601 is an icon indicating a bright & person (moving body) scene. An icon 602 is an icon indicating that the system control unit 50 has applied the basic image capturing setting for registrant. In this manner, display control of causing the display unit 28 to display the icon 602 indicating that the basic image capturing setting for registrant is applied to the digital camera 100 may be performed. An icon 603 is an icon indicating that the system control unit 50 has applied the specific scene image capturing setting for registrant. In this manner, display control of causing the display unit 28 to display the icon 603 indicating that the specific scene image capturing setting for registrant is applied to the digital camera 100 may be performed.

As described above, in the present embodiment, the image capturing setting that is a control condition of the digital camera is determined based on the photographer information and the scene recognition result, and the operation of the digital camera is controlled based on the control condition. This makes it possible to change to a desired setting for each individual without user operation, and therefore it is possible to perform image capturing without missing an opportunity.

### Second Embodiment

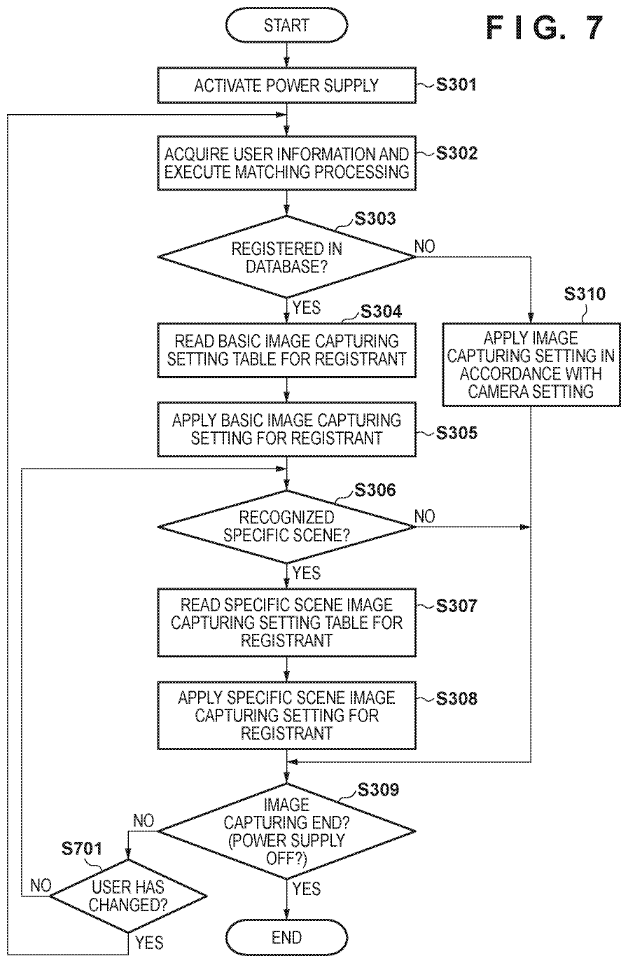

Hereinafter, an example of determining a control condition based on photographer information and a scene recognition result and controlling the operation of the digital camera 100 according to the second embodiment will be described with reference to FIG. 7. Since the apparatus configuration is similar to that of the first embodiment, the description will be omitted.

### Processing

FIG. 7 is a flowchart for determining the control condition based on the photographer information and the scene recognition result according to the second embodiment and controlling the operation of the digital camera 100. Each processing operation in the flowchart of FIG. 7 is implemented by the system control unit 50 deploying, into the system memory 52, a program stored in the nonvolatile memory 56 and executing the program, and controlling each functional block. Note that identical steps to those in the flowchart of FIG. 3 are denoted by identical symbols, and the description thereof will be omitted. However, in step S309, in a case where the user has not turned off the power supply of the digital camera 100, the process proceeds to step S701. The flowchart of FIG. 7 is started from a state in which the digital camera 100 is turned off.

In step S701, the user information acquisition unit 113 acquires user information. Then, the user information matching unit 112 determines whether or not the user has changed to another user based on the user information acquired by the user information acquisition unit 113. For example, it is determined whether or not the user has changed to another user by holding the user information acquired in step S302 and comparing it with the user information newly acquired in step S701. In a case where it is determined that the user has changed to another user, the process returns to step S302. In a case where the processing returns to step S302 after step S701, only the matching processing may be executed since the user information has already been acquired. On the other hand, in a case where it is determined that the user has not changed to another user, the process returns to step S306.

As described above, in the present embodiment, in a case where the newly acquired user information (photographer information) has changed from the previously acquired user information (photographer information), it is determined again whether or not the newly acquired user information is registered in the authorized user database. In this manner, while the photographer information is monitored in real time (temporally), the control condition is determined based on the photographer information and the scene recognition result, and the operation of the digital camera 100 is controlled.

This makes it possible to change to a desired setting for each individual without user operation, and therefore it is possible to perform image capturing without missing an opportunity. Furthermore, even in a case where the user (photographer) has changed to another user in the middle, it is possible to quickly change to a desired setting without user operation.

### Third Embodiment

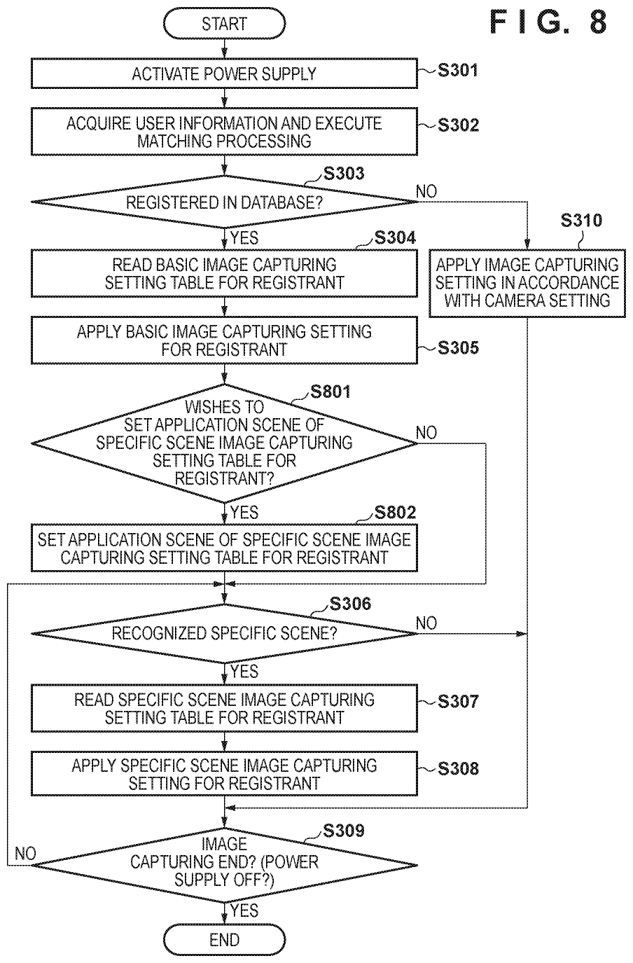

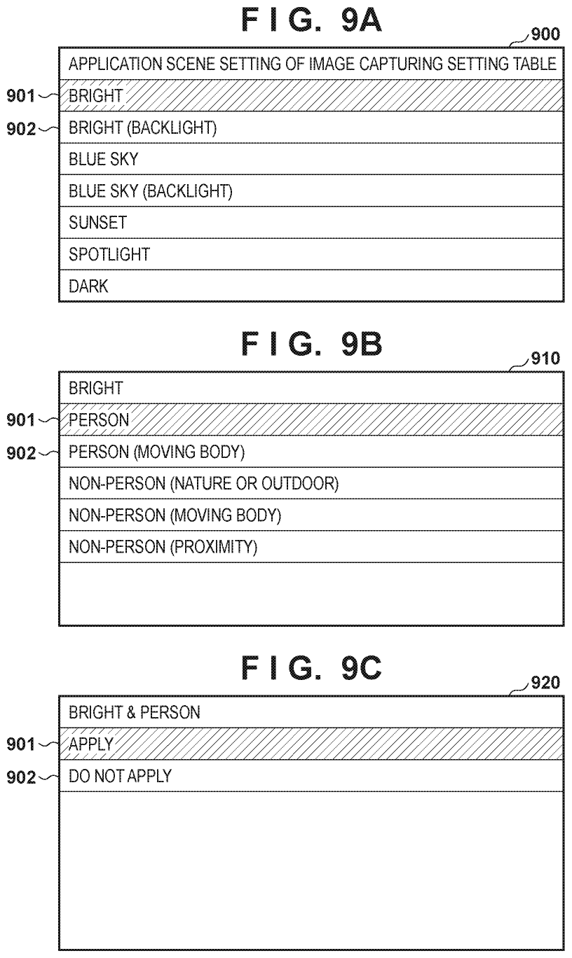

Hereinafter, an example of determining a control condition based on photographer information and a scene recognition result and controlling the operation of the digital camera 100 according to the third embodiment will be described with reference to FIGS. 8 and 9. Since the apparatus configuration is similar to that of the first embodiment, the description will be omitted.

### Processing

FIG. 8 is a flowchart for determining the control condition based on the photographer information and the scene recognition result according to the third embodiment and controlling the operation of the digital camera 100. Each processing operation in the flowchart of FIG. 8 is implemented by the system control unit 50 deploying, into the system memory 52, a program stored in the nonvolatile memory 56 and executing the program, and controlling each functional block. Note that identical steps to those in the flowchart of FIG. 3 are denoted by identical symbols, and the description thereof will be omitted. However, after the processing of step S305, the process proceeds to step S801. The flowchart of FIG. 8 is started from a state in which the digital camera 100 is turned off.

In step S801, the system control unit 50 confirms the presence or absence of the user's setting request for an application scene of the specific scene image capturing setting table for registrant. For example, a prompt to confirm to the user whether they want to make a setting request can be displayed, an input of whether to make the setting request can be accepted by the user input, and a determination can be made based on the input result. In a case where there is a setting request, the process proceeds to step S802. In a case where there is no setting request, the process proceeds to step S306.

In step S802, the system control unit 50 accepts the setting of the application scene of the specific scene image capturing setting table for registrant from the user. Thereafter, the process proceeds to step S306. The application scene setting of the specific scene image capturing setting table for registrant will be described later with reference to FIGS. 9A to 9C.

### MENU Setting Screen

FIGS. 9A to 9C are explanatory views illustrating MENU setting examples according to the third embodiment. FIG. 9A is a MENU setting example illustrating the first hierarchy of an application scene setting of the specific scene image capturing setting table for registrant. For example, a background condition of the image capturing scene can be selected. The background condition of the image capturing scene includes, but is not limited to, bright, bright (backlight), blue sky, blue sky (backlight), sunset, spotlight, and dark.

FIG. 9B is a MENU setting example illustrating the second hierarchy of an application scene setting of the specific scene image capturing setting table for registrant. For example, a subject condition for the background condition of the image capturing scene selected in FIG. 9A can be selected. The subject condition includes, but is not limited to, person, person (moving body), non-person (nature or outdoor), non-person (moving body), and non-person (macro).

FIG. 9C is a MENU setting example illustrating the third hierarchy of an application scene setting of the specific scene image capturing setting table for registrant. For example, it is possible to select the presence or absence of the application of the background condition of the image capturing scene selected in FIG. 9A and the subject condition setting selected in FIG. 9B. In this manner, an input as to whether to enable or disable the application of the setting of the control condition may be accepted for each image capturing scene, and the presence or absence of the application of the setting of the control condition may be changed for each image capturing scene based on the acceptance result.

A display screen 900 is an example of MENU setting for setting an application scene of the specific scene image capturing setting table for registrant. For example, the background conditions of the image capturing scene are displayed in a list. A display region 901 indicates that the user has selected. For example, the user can change the setting with the cross key 74. The user can also decide the setting by pressing the SET button 75. A display region 902 indicates that the user has not selected. A display screen 910 is an example of MENU setting for setting an application scene of the image capturing setting table. For example, the subject conditions for the background condition “bright” are displayed in a list. A display screen 920 is an example of MENU setting for setting an application scene of the image capturing setting table. For example, the presence or absence of the application of the setting to the background condition “bright” & the subject condition “person” is displayed.

As described above, in the present embodiment, the control condition is determined based on the photographer information and a predetermined scene recognition result, and the operation of the digital camera 100 is controlled. Then, the application scene of the specific scene image capturing setting table for registrant can be freely customized. This makes it possible to change to a desired setting for each individual without user operation, and therefore it is possible to perform image capturing without missing an opportunity.

Note that the customization described in the present embodiment is applicable not only to the specific scene image capturing setting table for registrant illustrated in FIG. 5 but also to the basic image capturing setting table for registrant illustrated in FIG. 4.

According to the present disclosure, it is possible to automatically perform a setting suitable for an image capturing scene for each individual. Therefore, it is possible to perform image capturing without missing an opportunity.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-052438, filed Mar. 26, 2025, which is hereby incorporated by reference herein in its entirety.

What is claimed is:

1. An electronic apparatus comprising:
an acquisition unit configured to acquire user information;
a recognition unit configured to recognize an image capturing scene based on image information acquired by an image capturing unit; and
a control unit configured to apply, to the electronic apparatus, a setting of a control condition of the electronic apparatus corresponding to the user information and the image capturing scene based on the user information and information on the image capturing scene recognized by the recognition unit.

2. The electronic apparatus according to claim 1, wherein in a case where the image capturing scene is not recognized by the recognition unit, the control unit applies, to the electronic apparatus, a second setting, which is a control condition of the electronic apparatus corresponding to the user information.

3. The electronic apparatus according to claim 1 further comprising:
a storage unit configured to register and store user information on the electronic apparatus in advance; and
a determination unit configured to determine whether or not the user information acquired by the acquisition unit is registered in the storage unit, wherein
in a case where it is determined that the user information is registered in the storage unit, the control unit applies, to the electronic apparatus, the setting corresponding to the user information and the image capturing scene.

4. The electronic apparatus according to claim 3, wherein in a case where it is determined that the user information is not registered in the storage unit, the control unit applies, to the electronic apparatus, a predetermined third setting, which is a control condition of the electronic apparatus.

5. The electronic apparatus according to claim 3, wherein
the acquisition unit temporally acquires the user information, and
in a case where user information newly acquired by the acquisition unit is changed from user information previously acquired by the acquisition unit, the determination unit determines again whether or not the newly acquired user information is registered in the storage unit.

6. The electronic apparatus according to claim 1, wherein the user information includes at least one of a fingerprint, a face, an iris, and a passkey.

7. The electronic apparatus according to claim 1, wherein the setting of the control condition includes a setting of at least one of a drive mode, a shutter system, a recording image quality, an AF method, and a still image crop aspect ratio.

8. The electronic apparatus according to claim 1, wherein the setting of the control condition is editable.

9. The electronic apparatus according to claim 1, wherein the setting of the control condition is a setting in accordance with a past use frequency by a user corresponding to the user information.

10. The electronic apparatus according to claim 1 further comprising a display control unit configured to cause a display unit of the electronic apparatus to display an icon indicating the image capturing scene recognized by the recognition unit.

11. The electronic apparatus according to claim 1 further comprising a display control unit configured to cause a display unit of the electronic apparatus to display an icon indicating that the setting is applied to the electronic apparatus by the control unit.

12. The electronic apparatus according to claim 2 further comprising a display control unit configured to cause a display unit of the electronic apparatus to display an icon indicating that the second setting is applied to the electronic apparatus by the control unit.

13. The electronic apparatus according to claim 1 further comprising
an acceptance unit configured to accept an input as to whether to enable or disable application of the setting of the control condition for each of the image capturing scenes, wherein
the control unit changes whether or not to apply the setting of the control condition for each of the image capturing scenes based on an acceptance result of the acceptance unit.

14. The electronic apparatus according to claim 1, wherein the electronic apparatus is a digital camera.

15. The electronic apparatus according to claim 14, wherein the user information is information on a photographer who performs image capturing using the digital camera.

16. A control method for an electronic apparatus, the control method comprising:
acquiring user information;
recognizing an image capturing scene based on image information acquired by an image capturing unit; and
applying, to the electronic apparatus, a setting of a control condition of the electronic apparatus corresponding to the user information and the image capturing scene based on the user information and information on the image capturing scene recognized by the recognizing.

17. A non-transitory computer-readable storage medium storing a program for causing a computer to execute a control method for an electronic apparatus, the control method including:
acquiring user information;
recognizing an image capturing scene based on image information acquired by an image capturing unit; and
applying, to the electronic apparatus, a setting of a control condition of the electronic apparatus corresponding to the user information and the image capturing scene based on the user information and information on the image capturing scene recognized by the recognizing.
